(19) United States
(12) Patent Application Publication
(10) Pub. No.: US 2025/0104903 A1
(43) Pub. Date: Mar. 27, 2025

(54) INTEGRATED COIL STRUCTURE

(71) Applicant: TAI-TECH ADVANCED ELECTRONICS CO., LTD., Taoyuan City (TW)

(72) Inventors: Ming-Yen Hsieh, Taoyuan City (TW); Pao-Lin Shen, Taoyuan City (TW); Hsiang-Chung Yang, Taoyuan City (TW); Wei-Hsuan Lo, Taoyuan City (TW)

(21) Appl. No.: 18/474,154

(22) Filed: Sep. 25, 2023

(51) Int. Cl. H01F 27/28; H01F 27/24

(52) U.S. Cl. CPC H01F 27/2823; H01F 27/24

(57) ABSTRACT

An improved integrated coil structure includes an iron core body and first, second, third, and fourth coils. The iron core body includes first and second wire-winding portions. The iron core body is provided with first and second flanges respectively at two sides thereof and a third flange arranged between the first and second flanges. First and second electrodes are arranged on the first flange. Third and fourth electrodes are arranged on the second flange. Fifth, sixth, and seventh electrodes are arranged on the third flange. Two terminals of the first coil are electrically connected with the first and fifth electrodes. Two terminals of the second coil are electrically connected with the second and seventh electrodes. Two terminals of the third coil are electrically connected with the third and sixth electrodes. Two terminals of the fourth coil are electrically connected with the fourth and seventh electrodes.

### BACKGROUND OF THE INVENTION

### (a) Technical Field of the Invention

The present invention relates generally to an improvement on an integrated coil, and more particularly to an improved integrated coil structure.

### (b) Description of the Prior Art

Taiwan Utility Model M569927 discloses an integrated coil structure, which, as shown in FIG. 3 the document, comprises a magnetic core body, a first section of winding, a second section of winding, a third section of winding, and a fourth section of winding. A first flange and a second flange are respectively arranged at two sides of the magnetic core body. A third flange is arranged on the magnetic core body between the first flange and the second flange. A first terminal electrode and a second terminal electrode are arranged on a bottom of the first flange; a third terminal electrode and a fourth terminal electrode are arranged on a bottom of the second flange; and a fifth terminal electrode and a sixth terminal electrode are arranged on a bottom of the third flange. Two ends of the first section of winding are electrically connected (through soldering) to the first terminal electrode and the fifth terminal electrode, respectively; two ends of the second section of winding are electrically connected (through soldering) to the fifth terminal electrode and the third terminal electrode, respectively; two ends of the third section of winding are electrically connected (through soldering) to the second terminal electrode and the sixth terminal electrode, respectively; and two ends of the fourth section of winding are electrically connected (through soldering) to the sixth terminal electrode and the fourth terminal electrode, respectively.

In a practical application, printed circuit board (PCB) tracing is used to electrically connect the second terminal electrode and the fifth terminal electrode to serve as a central tapping. This, however, causes shorting on the second section of winding that is soldered to the fifth terminal electrode, and this makes the structure defective in practical applications.

### SUMMARY OF THE INVENTION

In view of the above problem, an objective of the present invention is to provide an improved integrated coil structure.

To fulfill the above objective, the present invention provides an improved integrated coil structure, which comprises:
an iron core body, wherein the iron core body comprises a first wire-winding portion and a second wire-winding portion, the iron core body being provided with a first flange and a second flange respectively at two sides of and a third flange arranged between the first flange and the second flange, the first wire-winding portion being arranged between the first flange and the third flange, the second wire-winding portion being arranged between the second flange and the third flange, a first electrode and a second electrode being arranged on the first flange, a third electrode and a fourth electrode being arranged on the second flange, a fifth electrode, a sixth electrode, and a seventh electrode being arranged on the third flange;
a first coil, wherein the first coil comprises a first terminal and a second terminal, where the first terminal of the first coil is electrically connected with the first electrode and the second terminal of the first coil is electrically connected with the fifth electrode, and is wound around the first wire-winding portion;
a second coil, wherein the second coil comprises a first terminal and a second terminal, where the first terminal of the second coil is electrically connected with the second electrode and the second terminal of the second coil is electrically connected with the seventh electrode, and is wound around the first wire-winding portion;
a third coil, wherein the third coil comprises a first terminal and a second terminal, where the first terminal of the third coil is electrically connected with the sixth electrode and the second terminal of the third coil is electrically connected with the third electrode, and is wound around the second wire-winding portion; and
a fourth coil, wherein the fourth coil comprises a first terminal and a second terminal, where the first terminal of the fourth coil is electrically connected with the seventh electrode and the second terminal of the fourth coil is electrically connected with the fourth electrode, and is wound around the second wire-winding portion.

In practical applications of the present invention, the above-described structure makes the third coil not affected by electrical connection of the second electrode and the fifth electrode to get shorting.

### BRIEF DESCRIPTION OF THE DRAWINGS

FIG. 1 is a schematic bottom view showing the present invention.

FIG. 2 is a schematic view showing the present invention provided with a first external circuit and a second external circuit.

### DETAILED DESCRIPTION OF THE PREFERRED EMBODIMENTS

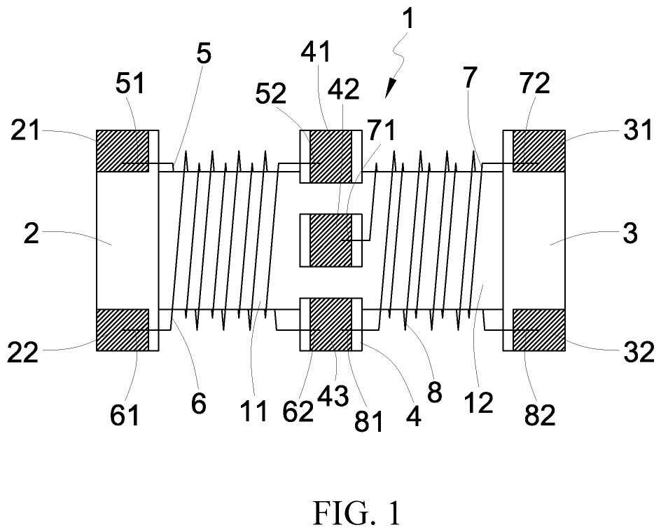

Referring to FIG. 1, an improved integrated coil structure comprises:
an iron core body 1, wherein the iron core body 1 comprises first wire-winding portion 11 and the second wire-winding portion 12, the iron core body 1 being provided with a first flange 2 and a second flange 3 respectively at two sides thereof, and a third flange 4 arranged between the first flange 2 and the second flange 3, the first wire-winding portion 11 being arranged between the first flange 2 and the third flange 4, the second wire-winding portion 12 being arranged between the second flange 3 and the third flange 4, a first electrode 21 and a second electrode 22 being arranged on the first flange 2, a third electrode 31 and a fourth electrode 32 being arranged on the second flange 3, a fifth electrode 41, a sixth electrode 42, and a seventh electrode 43 being arranged on the third flange 4;
a first coil 5, wherein the first coil 5 has a first terminal 51 and a second terminal 52, where the first terminal 51 of the first coil 5 is electrically connected with the first electrode 21 and the second terminal 52 of the first coil 5 is electrically connected with the fifth electrode 41, and is wound around the first wire-winding portion 11;
a second coil 6, wherein the second coil 6 has a first terminal 61 and a second terminal 62, where the first terminal 61 of the second coil 6 is electrically connected with the second electrode 22 and the second terminal 62 of the second coil 6 is electrically connected with the seventh electrode 43, and is wound around the first wire-winding portion 11;
a third coil 7, wherein the third coil 7 has a first terminal 71 and a second terminal 72, where the first terminal 71 of the third coil 7 is electrically connected with the sixth electrode 42 and the second terminal 72 of the third coil 7 is electrically connected with the third electrode 31, and is wound around the second wire-winding portion 12; and
a fourth coil 8, wherein the fourth coil 8 has a first terminal 81 and a second terminal 82, where the first terminal 81 of the fourth coil 8 is electrically connected with the seventh electrode 43 and the second terminal 82 of the fourth coil 8 is electrically connected with the fourth electrode 32, and is wound around the second wire-winding portion 12.

In the above structure, the first coil 5 and the second coil 6 are arranged, in parallel, on the first wire-winding portion 11.

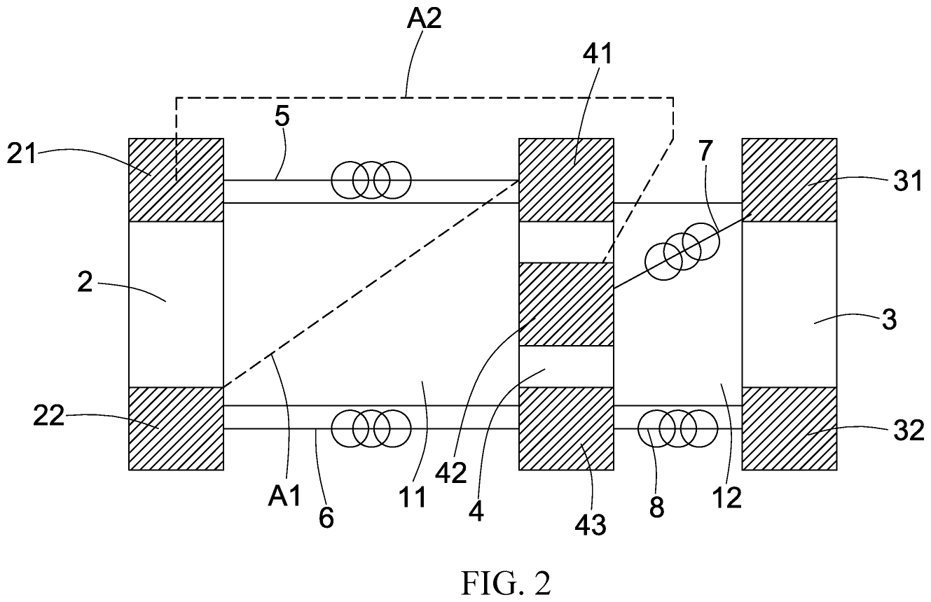

Referring to FIGS. 1 and 2, a first external circuit A1 is arranged between the second electrode 22 and the fifth electrode 41. The first external circuit A1 electrically connect the second electrode 22 and the fifth electrode 41 with each other to allow the second electrode 22 and the fifth electrode 41 to function as central tapping. The first external circuit A1 can be printed circuit board (PCB) tracing.

In the above structure, a second external circuit A2 is arranged between the first electrode 21 and the sixth electrode 42. The second external circuit A2 electrically connects the first electrode 21 and the sixth electrode 42 with each other to allow a signal to be transmitted from the first electrode 21 to the sixth electrode 42 to be then transmitted through the third coil 7 to the third electrode 31. The second external circuit A2 can be PCB tracing.

In the above structure, another signal is transmitted from the seventh electrode 43 through the fourth coil 8 to the fourth electrode 32.

Compared with the prior art, the present invention provides an arrangement that the sixth electrode 42 is set on the third flange 4 and the two terminals of the third coil 7 are electrically connected with the third electrode 31 and the sixth electrode 42, respectively, so that in a practical application, the third coil 7 does not get shorting due to electrical connection of the second electrode 22 and the fifth electrode 41, and in a practical application, the second external circuit A2 electrically connects the first electrode 21 and the sixth electrode 42 to allow a signal to transmit from the first electrode 21 through the second external circuit A2 to the sixth electrode 42 to subsequently transmit through the third coil 7 to the third electrode 31, while another signal transmits from the seventh electrode 43 through the fourth coil 8 to the fourth electrode 32.

I claim:

1. An integrated coil structure, comprising:
an iron core body, wherein the iron core body comprises a first wire-winding portion and a second wire-winding portion, the iron core body being provided with a first flange and a second flange respectively at two sides of and a third flange arranged between the first flange and the second flange, the first wire-winding portion being arranged between the first flange and the third flange, the second wire-winding portion being arranged between the second flange and the third flange, a first electrode and a second electrode being arranged on the first flange, a third electrode and a fourth electrode being arranged on the second flange, a fifth electrode, a sixth electrode, and a seventh electrode being arranged on the third flange;
a first coil, wherein the first coil comprises a first terminal and a second terminal, where the first terminal of the first coil is electrically connected with the first electrode and the second terminal of the first coil is electrically connected with the fifth electrode, and is wound around the first wire-winding portion;
a second coil, wherein the second coil comprises a first terminal and a second terminal, where the first terminal of the second coil is electrically connected with the second electrode and the second terminal of the second coil is electrically connected with the seventh electrode, and is wound around the first wire-winding portion;
a third coil, wherein the third coil comprises a first terminal and a second terminal, where the first terminal of the third coil is electrically connected with the sixth electrode and the second terminal of the third coil is electrically connected with the third electrode, and is wound around the second wire-winding portion; and
a fourth coil, wherein the fourth coil comprises a first terminal and a second terminal, where the first terminal of the fourth coil is electrically connected with the seventh electrode and the second terminal of the fourth coil is electrically connected with the fourth electrode, and is wound around the second wire-winding portion.

2. The integrated coil structure according to claim 1, wherein the first coil and the second coil are arranged in parallel on the first wire-winding portion.

3. The integrated coil structure according to claim 1, wherein a first external circuit is arranged between the second electrode and the fifth electrode.

4. The integrated coil structure according to claim 3, wherein the first external circuit comprises printed circuit board (PCB) tracing.

5. The integrated coil structure according to claim 1, wherein a second external circuit is arranged between the first electrode and the sixth electrode.

6. The integrated coil structure according to claim 5, wherein the second external circuit comprises PCB tracing.
